(19) United States
(12) Patent Application Publication
(10) Pub. No.: US 2021/0071689 A1
(43) Pub. Date: Mar. 11, 2021

(54) CONTROL VALVE, DERRICKING CYLINDER AND WORKING METHOD THEREOF, AERIAL WORK PLATFORM

(71) Applicant: ZHEJIANG DINGLI MACHINERY CO., LTD, Huzhou (CN)

(72) Inventor: Shugen XU, Huzhou (CN)

(21) Appl. No.: 16/751,270

(22) Filed: Jan. 24, 2020

(30) Foreign Application Priority Data
Sep. 6, 2019 (CN) 2019108411194

(51) Int. Cl. F15B 15/02; B66F 11/04; F15B 15/20; F16K 31/06; F16K 39/00

(52) U.S. Cl. CPC F15B 15/02; B66F 11/044; F16K 39/00; F16K 31/06; F15B 15/20

(57) ABSTRACT

Provided are a control valve, a derricking cylinder and a working method thereof, and an aerial work platform, relating to the field of aerial work. The control valve of the derricking cylinder includes a first balance valve provided on the oil circuit between the first port G and the second port F, and a second balance valve provided on the oil circuit between the third port H and the fourth port E; and a switch valve in series with the first balance valve is further provided on the oil circuit between the first port G and the second port F.

### TECHNICAL FIELD

The present disclosure relates to the field of aerial work, and more particularly to a control valve, a derricking cylinder and the working method thereof, an aerial work platform.

### BACKGROUND

The aerial work platform is an advanced aerial work mechanism that can greatly improve the work efficiency, safety and comfort of air construction workers and reduce labor intensity. It has been widely used in developed countries. The use of aerial work platforms in China is also becoming more and more extensive, such as the initial general municipal street lamp maintenance, garden tree trimming, etc. With the rapid development of China's economy, The demands for aerial work platforms in engineering construction, industrial installation, equipment maintenance, plant maintenance, shipbuilding, electric power, municipal administration, airports, communications, gardens, and transportation are growing.

Chinese patent with appl. No.: CN201810449467.2 discloses an aerial work platform including a lifting portion and a walking portion, the walking portion including a base, the lifting portion including a folding arm, a main arm, a secondary arm and a work bucket, which are sequentially connected. One end of the folding arm is hinged to a turntable, the turntable is connected to the base by a slewing bearing. One end of the main arm is hinged to the other end of the folding arm, one end of the secondary arm is hinged to the other end of the main arm. The work bucket is connected to the other end of the secondary arm. A small arm head is provided at a joint of the main arm connected with the secondary arm, and a small arm leveling cylinder is provided between the small arm head and the main arm. The folding arm is a telescopic structure or is composed of a link mechanism, and the folding arm is internally provided with a folding arm telescopic cylinder for controlling the telescopic movement of the folding arm. A folding arm derricking cylinder is provided between the folding arm and the turntable. The main arm has a retractable structure, and is internally provided with a main arm telescopic cylinder for controlling the main arm's telescopic movement. A main arm derricking cylinder is provided between the main arm and the folding arm, and a secondary arm derricking cylinder is provided between the secondary arm and the main arm.

The conventional derricking cylinder 100 shown in FIG. 1 includes a single rod double acting piston type hydraulic cylinder 200 and a control valve 300, and the control valve 300 is used for controlling the rod cavity 2 and the rodless cavity 1 of the hydraulic cylinder 200 respectively to perform turn-on or turn-off with the oil supply pressure circuit or the oil return system. The control valve 300 includes a first balance valve 400 and a second balance valve 500, the first balance valve 400 includes a first one-way functional portion 4 and a first overflow function portion 5. The second balance valve 500 includes a second one-way functional portion 6 and a second overflow function portion 7, and the control port of the first overflow function portion 5 communicates with the oil outlet of the second overflow function portion 7. The control port of the second overflow functional portion 7 communicates with the oil outlet of the first overflow function portion 5. The port C1 of the first balance valve 400 located at one end of the oil outlet of the first one-way function portion 4 is in communication with the rodless cavity 1 of the hydraulic cylinder 200, and the port C2 of the second balance valve 500 located at one end of the oil outlet of the second one-way function portion 6 communicates with the rod cavity 2 of the hydraulic cylinder 200.

When the amplitude varies upwardly, as shown in FIG. 2, the pressure oil enters the first balance valve 400 from the port V1 of the first balance valve 400 at the oil inlet end of the first one-way functional portion 4, and then flows out from the port C1 through the first one-way functional portion 4, while a part of the pressure oil flows from the oil outlet of the first overflow function portion 5 into the control port of the second overflow function portion 7, and turns on the second overflow function portion 7. The pressure oil flowing out from the port C1 flows into the rodless cavity 1 of the hydraulic cylinder 200, at the same time the hydraulic oil of the rod cavity 2 of the hydraulic cylinder 200 passes through the second overflow function portion 7, and discharges from the port V2 of the second balance valve 500 located at one end of the oil inlet port of the second one-way functional portion. The piston rod 3 of the hydraulic oil cylinder is extended, and the amplitude of the lifting arm of the aerial work platform varies upward.

When the amplitude varies downwardly, as shown in FIG. 3, the pressure oil enters the second balance valve 500 from the port V2 of the second balance valve 500 at the oil inlet end of the second one-way function portion 6, and then flows out from the port C2 through the second one-way function portion 6, while a part of the pressure oil flows from the oil outlet of the second overflow function portion 7 into the control port of the first overflow function portion 5, and turns on the first overflow function portion 5. The pressure oil flowing out from the port C2 flows into the rod cavity 2 of the hydraulic cylinder 200, and the return oil of the rodless cavity 1 of the hydraulic cylinder 200 passes through the first overflow function portion 5, and discharges from the port V1 of the first balance valve 400 located at one end of the oil inlet port of the first one-way function portion 4. The piston rod 3 of the hydraulic oil cylinder is retracted, and the amplitude of the lifting arm of the aerial work platform varies downwardly.

When at rest, as shown in FIG. 4, the oil supply system does not supply the hydraulic oil to the hydraulic cylinder 200, and the rodless cavity 1 of the hydraulic cylinder 200 and the oil of the rod cavity 2 are sealed by the first balance valve 400 and the second balance valve 500. The rodless cavity 1 maintains high pressure, the rod cavity 2 maintains a relatively high pressure, and the oil pressure of the rodless cavity 1 is balanced with the oil pressure of the rod cavity 2 and the gravity of the lifting arm. The piston rod 3 of the hydraulic cylinder 200 is neither extended, nor retracted. The lifting arm remains at rest.

Due to the complicated structure of the balance valve, once the first balance valve 400 connected to the rodless cavity 1 fails, as shown in FIG. 5, the oil of the rodless cavity 1 of the hydraulic cylinder 200 enters the oil return system, and the piston rod 3 of the hydraulic cylinder 200 continues to retract, the lifting arm descends. When the aerial work platform is at aerial work state, it is easy to cause the work bucket to tilt and cause the operator to fall, even the gravity centre position of the whole machine exceeds the tilting line, resulting in the overall tilting of the aerial work platform, thereby a serious accident occurs.

### SUMMARY

The purpose of the present disclosure is to make up for the defects of the prior art, and to provide a control valve, a derricking cylinder and a working method thereof, and an aerial work platform, which prevent the balance valve of the derricking cylinder and the rodless cavity from failing, thereby resulting in accident.

According to a first aspect of the present disclosure, a control valve includes an oil circuit provided between a first port G and a second port F, and an oil circuit provided between a third port H and a fourth port E; a first balance valves connected in series with a switch valve is provided in the oil circuit between the first port G and the second port F.

Further, the switch valve is a two-position two-way solenoid valve or a proportional valve, and the control valve further includes an electronic control unit electrically connected to the switch valve.

Further, the first balance valve and the switch valve are integrated in a valve body, and the first port G, the second port F, the third port H and the fourth port E are located in a surface of the valve body.

Further, the first balance valve includes a first one-way functional portion and a first overflow function portion, a control port of the first overflow function portion communicates with the oil circuit between the third port H and the fourth port E; and a third oil mouth located at one end of the oil inlet of the first overflow function portion of the first balance valve is connected to the second port F, a second oil mouth located at one end of the oil inlet of the first one-way function portion of the first balance valve is connected to the first port G.

Further, the first overflow function portion is a pilot type structure, and a spring side control cavity of the first overflow function portion is in communication with an oil outlet of the first overflow function portion, and a spring-free side control cavity of the first overflow function portion is in communication with an oil inlet of the first overflow function portion.

Further, a second balance valve is provided on the oil circuit between the third port H and the fourth port E.

Further, the first balance valve, the second balance valve and the switch valve are integrated in one valve body, the first port G, the second port F, the third port H and the fourth port E are located on a surface of the valve body.

Further, the first balance valve includes a first one-way functional portion and a first overflow function portion, and the second balance valve includes a second one-way functional portion and a second overflow function portion. The control port of the first overflow function portion is in communication with the first oil mouth located at one end of the oil inlet of the second one-way function portion of the second balance valve; and the control port of the second overflow function portion is in communication with the second oil mouth located at one end of the oil inlet of the first one-way function portion of the first balance valve; and a third oil mouth located at one end of the oil inlet of the first overflow function portion of the first balance valve is connected to the second port F; and the second oil mouth is connected to the first port G, the first oil mouth is connected to the third port H; and a fourth oil mouth located at one end of the oil inlet of the second overflow function portion of the second balance valve is connected to the fourth port E.

Further, both the first overflow function portion and the second overflow function portion are pilot type structures, and a spring side control cavity of the first overflow function portion communicates with the oil outlet of the first overflow function portion, a spring-free side control cavity of the first overflow function portion communicates with the oil inlet of the first overflow function portion; and a spring side control cavity of the second overflow function portion communicates with the oil outlet of the second overflow function portion, and a spring-free side control cavity of the second overflow function portion is in communication with the oil inlet of the second overflow function portion.

Further, the switch valve is provided on the oil circuit between the first port G and the first balance valve, and the control valve further includes a hydraulic sensor configured to monitor the pressure on the oil circuit between the switch valve and the first balance valve; and an electronic control unit electrically connected to the hydraulic sensor; and an alarm device electrically connected to the electronic control unit.

Further, the valve body surface is further provided with a fifth port M connected to the oil circuit between the switch valve and the first balance valve, and the hydraulic sensor is arranged on the fifth port M.

According to a second aspect of the present disclosure, a derricking cylinder includes a hydraulic cylinder and a control valve according to the first aspect, the hydraulic cylinder is a single rod double acting piston type hydraulic cylinder, and the second port F communicates with a rodless cavity of the hydraulic cylinder, the fourth port E communicates with a rod cavity of the hydraulic cylinder.

According to a third aspect of the present disclosure, a working method of a derricking cylinder includes a hydraulic cylinder and a control valve according to the first aspect. The hydraulic cylinder is a single rod double acting piston type hydraulic cylinder. The second port F is in communication with the rodless cavity of the hydraulic cylinder, and the fourth port E is in communication with the rod cavity of the hydraulic cylinder; the working method includes:

when the amplitude varies upwardly, the switch valve being turned on, and pressure oil flowing from the first port G into the control valve, and flowing out of the control valve from the second port F through the switch valve and the first balance valve, and then flowing into the rodless cavity of the hydraulic cylinder, the oil in the rod cavity of the hydraulic cylinder flowing from the fourth port E into the control valve, and flowing out the control valve from the third port H through the second balance valve, and then entering the oil return system, the piston rod of the hydraulic cylinder being extended;

when the amplitude varies downwardly, the switch valve being turned on, and the pressure oil flowing into the control valve from the third port H, and flowing out of the control valve from the fourth port E through the second balance valve, then flowing into the rod cavity of the hydraulic cylinder, the oil in the rodless cavity of the hydraulic cylinder flowing from the second port F into the control valve, and flowing out of the control valve from the first port G through the switch valve and the first balance valve, and then entering the oil return system, the piston rod of the hydraulic cylinder being retracted;

when at rest, no pressure oil flowing into the control valve, and the switch valve being cut off, the oil in the rodless cavity of the hydraulic cylinder being sealed by the control valve, and the hydraulic cylinder entering a holding state.

Further, the switch valve is a two-position two-way solenoid valve or a proportional valve, and the control valve further includes an electronic control unit electrically connected to the switch valve, and the conduction and interruption of the switch valve is controlled by the electronic control unit.

Further, the switch valve is provided on the oil circuit between the first port G and the first balance valve, and the control valve further includes a hydraulic sensor configured to monitor the pressure on the oil circuit between the switch valve and the first balance valve; an electronic control unit electrically connected to the hydraulic sensor; and an alarm device electrically connected to the electronic control unit. When the hydraulic sensor detects that the pressure on the oil circuit between the switch valve and the first balance valve deviates from the preset range, the electronic control unit controls the alarm device to perform an alarm.

According to a fourth aspect of the invention, an aerial work platform includes a lifting portion and a walking portion, the lifting portion includes the above-described derricking cylinder for driving the lifting portion to be lifted and lowered.

Further, the walking portion includes a base, and the lifting portion includes a folding arm, a main arm, a secondary arm and a work bucket, which are sequentially connected. One end of the folding arm is hinged to a turntable, the turntable is connected to the base by a slewing bearing. One end of the main arm is hinged to the other end of the folding arm, one end of the secondary arm is hinged to the other end of the main arm. The work bucket is connected to the other end of the secondary arm. A small arm head is provided at a joint of the main arm connected with the secondary arm, and a small arm leveling cylinder is provided between the small arm head and the main arm. The folding arm is a telescopic structure or includes a link mechanism, and the folding arm is internally provided with a folding arm telescopic cylinder for controlling the telescopic movement of the folding arm. A folding arm derricking cylinder is provided between the folding arm and the turntable. The main arm has a retractable structure, and is internally provided with a main arm telescopic cylinder for controlling the main arm's telescopic movement. A main arm derricking cylinder is provided between the main arm and the folding arm, and a secondary arm derricking cylinder is provided between the secondary arm and the main arm. At least one of the folding arm derricking cylinder, the main arm derricking cylinder and the secondary arm derricking cylinder is the above-described derricking cylinder.

The beneficial effects of the present disclosure are that:

1. when the first balance valve fails, the oil can be prevented from entering the oil return system from the oil circuit between the first port G and the second port F by cutting the switch valve off, and the operational reliability of the control valve is higher than the conventional one that only the balance valve exists;

2, the control valve is integrated in a valve body, it is modular and easy to install, and versatile, can be installed on different models.

3. when the first balance valve in the rodless cavity of the derricking cylinder fails, the oil can be prevented from returning from the oil circuit between the first port G and the second port F by cutting off the switch valve. The control valve seals the high-pressure oil in the rodless cavity of the derricking cylinder, and the lifting arm remains at rest. It is avoided that the uncontrolled downward movement causes the work bucket to tilt or the overall work platform to tip over, and the safety of the aerial work platform is higher.

4. the hydraulic sensor detects the pressure of the oil circuit between the first balance valve and the switch valve in real time. When the first balance valve fails, the abnormal pressure signal is transmitted to the electronic control unit, and the system alarms and prompts to replace the rodless cavity side first balance valve, to ensure that the oil circuit from the rodless cavity oil always has double insurance, which further improves the reliability of the control valve and the safety of the aerial work platform.

### BRIEF DESCRIPTION OF THE DRAWINGS

In order to more clearly illustrate the technical solution of the present disclosure, the drawings used in the description of the present disclosure will be briefly described below. It is obvious that the drawings described below are only used for some embodiments of the present disclosure. Other drawings may also be obtained from those of ordinary skill in the art without the inventive work.

FIG. 1 is a schematic diagram showing a hydraulic principle of a conventional derricking cylinder.

FIG. 2 is a schematic view showing the hydraulic principle of the conventional derricking cylinder when the amplitude varies upwardly.

FIG. 3 is a schematic diagram showing the hydraulic principle of the conventional derricking cylinder when the amplitude varies downwardly.

FIG. 4 is a schematic view showing the hydraulic principle of the conventional derricking cylinder at rest.

FIG. 5 is a schematic diagram showing a hydraulic principle when a rodless cavity balance valve of the conventional derricking cylinder fails.

FIG. 6 is a schematic view showing a hydraulic principle according to an embodiment of the present disclosure.

FIG. 7 is a schematic view showing the hydraulic principle of a derricking cylinder according to an embodiment of the present disclosure.

FIG. 8 is a schematic view showing the hydraulic principle of the derricking cylinder when the amplitude varies upwardly according to an embodiment of the present disclosure.

FIG. 9 is a schematic view showing the hydraulic principle of the derricking cylinder the amplitude varies downwardly according to an embodiment of the present disclosure.

FIG. 10 is a schematic view showing the hydraulic principle of the derricking cylinder at rest according to an embodiment of the present disclosure.

FIG. 11 is a schematic view showing the hydraulic principle of the derricking cylinder when the rodless cavity balance valve fails according to an embodiment of the present disclosure.

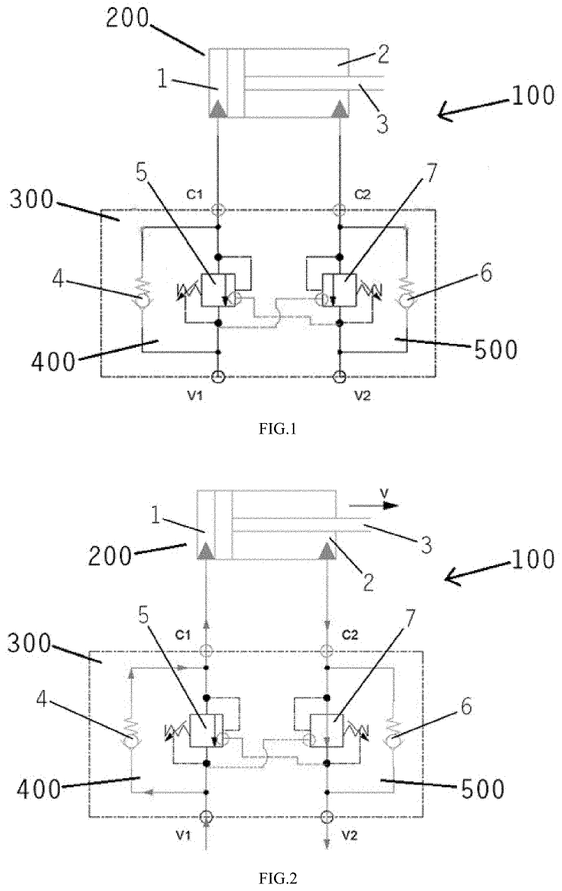

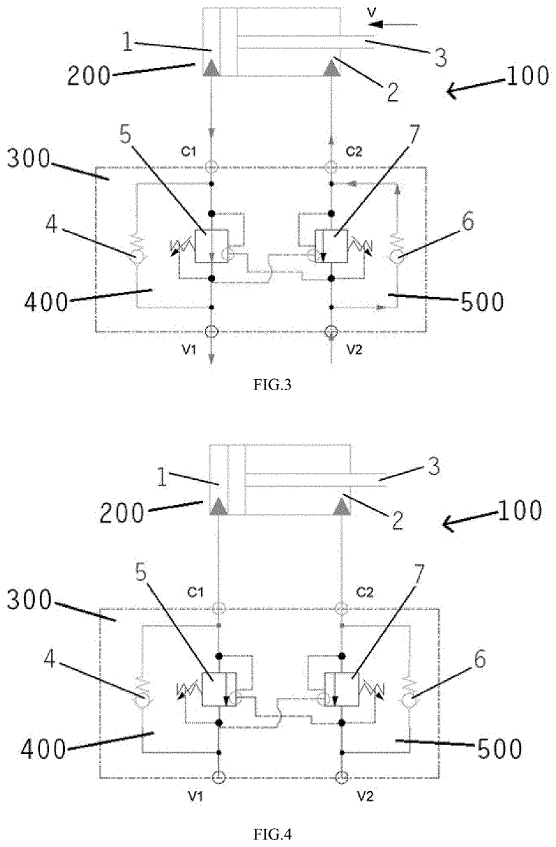

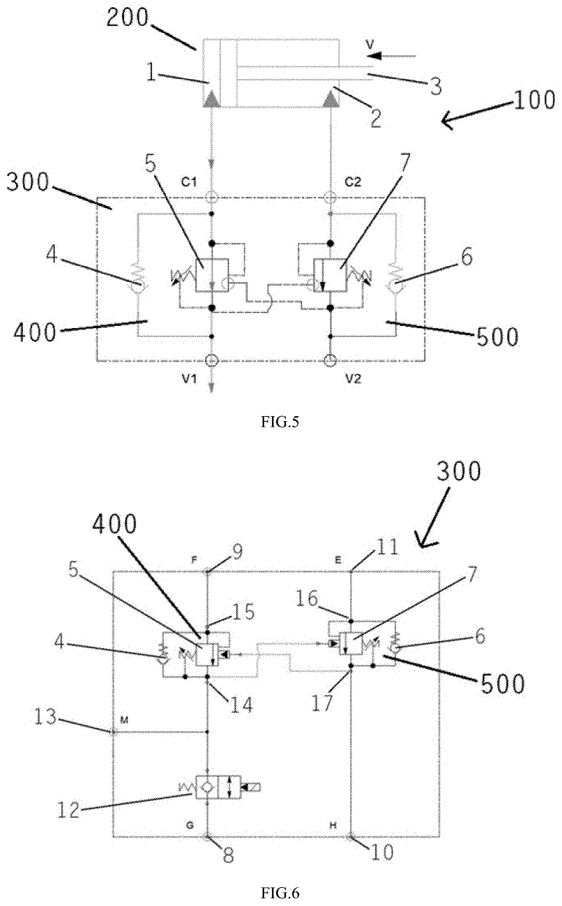

wherein,

1—rodless cavity; 2—rod cavity; 3—piston rod; 4—first one-functional portion; 5—first overflow function portion; 6—second one-functional portion; 7—second overflow function portion; 8—first port G; 9—second port F; 10—third port H; 11—fourth port E; 12—switch valve; 13—fifth port M; 14—second oil mouth; 15—third oil mouth; 16—fourth oil mouth; 17—first oil mouth; 18—hydraulic sensor; 100—derricking cylinder; 200—hydraulic cylinder; 300—control valve; 400—first balance valve; 500—second balance valve.

### DETAILED DESCRIPTION OF EMBODIMENTS

The technical solution in the present disclosure are clearly and completely described below with reference to the accompanying drawings. The embodiments described are only parts of the embodiments of the present disclosure. It is obvious that all other embodiments obtained by those skilled in the art based on the embodiments of the present disclosure without creative efforts shall fall within the scope of the present disclosure.

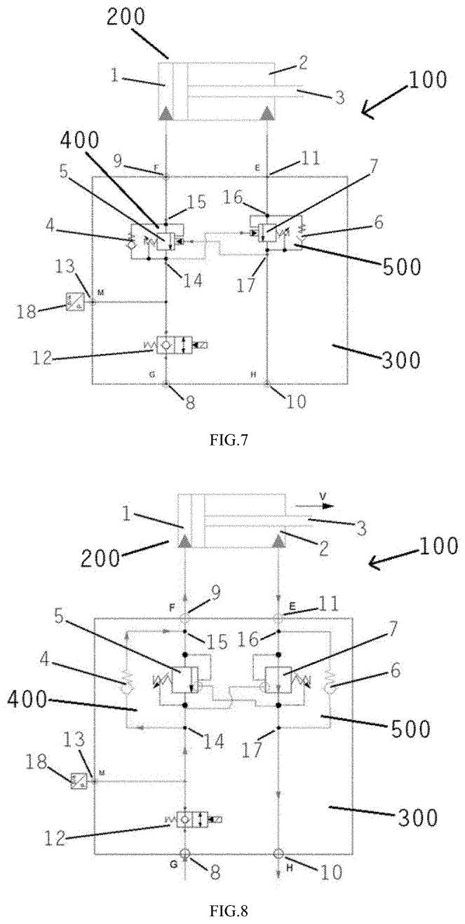

FIG. 6 is a schematic diagram of a hydraulic principle of a control valve 300 according to an embodiment of the present disclosure. As shown in FIG. 6, the control valve 300 may include a first balance valve 400 provided on an oil circuit between a first port G 8 and a second port F 9, and a second balance valve 500 provided on the oil circuit between a third port H 10 and a fourth port E 11. The first balance valve 400 may include a first one-way functional portion 4 and a first overflow function portion 5, the second balance valve 500 may include a second one-way functional portion 6 and a second overflow function portion 7. A control port of the first overflow function portion 5 can communicates with a first oil mouth 17 at one end of the oil inlet port of the second one-way functional portion 6 of the second balance valve 500. A control port of the second overflow function portion 7 can communicates with a second oil mouth 14 at the oil inlet end of the first one-way function portion 4 of the first balance valve 400. A third oil mouth 15 at one end of the oil inlet port of the first overflow function portion 5 of the first balance valve 400 can be connected to the second port F 9, and the second oil mouth 14 can be connected to the first port G 8, the first oil mouth 17 can be connected to the third port H 10. A fourth oil mouth 16 at one end of the oil inlet port of the second overflow function portion 7 of the second balance valve 500 may be connected to the fourth port E 11. The first overflow function portion 5 and the second overflow function portion 7 can be pilot type structures. A spring side control cavity of the first overflow function portion 5 can communicates with the oil outlet port of the first overflow function portion 5, and a spring-free side control cavity of the first overflow function portion 5 can communicates with the oil inlet port of the first overflow function portion 5. A spring side control cavity of the second overflow function portion 7 can be connected to the oil outlet of the second overflow function portion 7, and the spring-free side control cavity of the second overflow function portion 7 may be in communication with the oil inlet of the second overflow function portion 7. The oil circuit between the first port G 8 and the second port F 9 may be further provided with a switch valve 12 connected in series with the first balance valve 400, the switch valve 12 can be provided on the oil circuit between the first port G 8 and the first balance valve 400.

FIG. 7 is a schematic diagram showing a hydraulic principle of a derricking cylinder 100 according to an embodiment of the present disclosure. As shown in FIG. 7, the hydraulic cylinder 200 and the control valve 300 above-mentioned may be included. The hydraulic cylinder 200 can be a single rod double acting piston type hydraulic cylinder 200. The second port F 9 may be in communication with the rodless cavity 1 of the hydraulic cylinder 200, and the fourth port E 11 may be in communication with the rod cavity 2 of the hydraulic cylinder 200.

FIG. 8 is a schematic diagram of the hydraulic principle when the derricking cylinder 100 when the amplitude varies upward according to the embodiment of the present disclosure. When the amplitude varies upward, as shown in FIG. 8, the switch valve 12 can enter a turn-on state, and the pressure oil can flow from the first port G 8 into the control valve 300, and may flow out of the control valve 300 from the second port F 9 through the switch valve 12 and the first one-way function portion 4. While the pressure oil flowing out from the switch valve 12 can enter the first one-way functional portion 4, part of the pressure oil further may flow from the second oil mouth 14 at one end of the oil inlet of the first one-way functional portion 4 of the first balance valve 400 into the control port of second overflow function portion 7, thereby conducting the second overflow function portion 7. The pressure oil flowing out of the control valve 300 from the second port F 9 then flows into the rodless cavity 1 of the hydraulic cylinder 200, and the oil in the rod cavity 2 of the hydraulic cylinder 200 flows into the control valve 300 through the fourth port E 11, and flows out of the control valve 300 from the third port H 10 through the second overflow function portion 7, and then enters the oil return system. The piston rod 3 of the hydraulic cylinder 200 may be extended, the lifting arm of the aerial work platform may swing upward.

FIG. 9 is a schematic view showing the hydraulic principle of the derricking cylinder 100 when the amplitude varies downward according to the embodiment of the present disclosure. When the amplitude varies downward, as shown in FIG. 9, the switch valve 12 may enter a turn-on state. The pressure oil can flow into the control valve 300 from the third port H 10, and flow out of the control valve 300 from the fourth port E 11 through the second one-way function portion 6 of the second balance valve 500. While the pressure oil flowing into the control valve 300 flows into the second one-way functional portion 6, a part of the pressure oil may further flow from the first oil mouth 17 at the end of the oil inlet port of the second one-way functional portion 6 of the second balance valve 500 into the control port of the first overflow function portion 5, thereby turning on the first overflow function portion 5. The pressure oil flowing out of the control valve 300 from the fourth port E 11 then flows into the rod cavity 2 of the hydraulic cylinder 200, and the oil in the rodless cavity 1 of the hydraulic cylinder 200 flows from the second port F 9 into the control valve 300, and flows out of the control valve 300 from the first port G 8 through the first overflow function portion 5 and the switch valve 12, and then enters the oil return system. The piston rod 3 of the hydraulic cylinder 200 is retracted, the lifting arm of the aerial work platform varies downward.

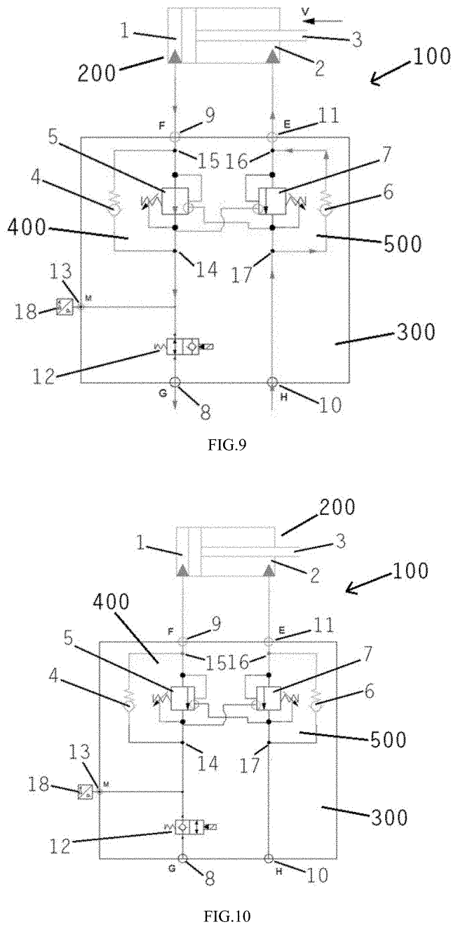

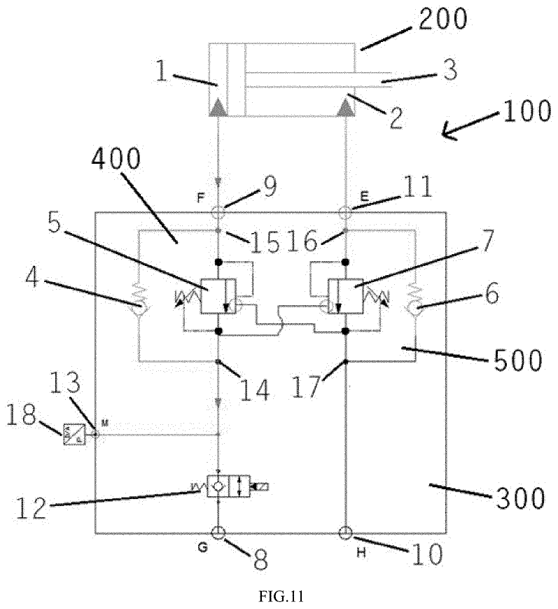

FIG. 10 is a schematic view showing the hydraulic principle of the derricking cylinder 100 when at rest. When the derricking cylinder 100 is at rest, as shown in FIG. 10, no pressure oil flows into the control valve 300, and the switch valve 12 is cut off. The oil in the rodless cavity 1 of the hydraulic cylinder 200 can be sealed by the control valve 300. Since the first overflow function portion 5 or the second overflow function portion 7 is turned off without the pressure oil flowing in, the oil in the rodless cavity 1 and the rod cavity 2 of the hydraulic cylinder 200 cannot return through the first balance valve 400 or the second balance valve 500. The piston rod 3 of the hydraulic cylinder 200 neither protrudes nor retracts, and the lifting arm of the aerial work platform is at rest.

FIG. 11 is a schematic diagram showing the hydraulic principle when the rodless cavity balance valve of the derricking cylinder 100 fails according to the embodiment of the present disclosure. When the first balance valve 400 of the above-described derricking cylinder 100 fails, as shown in FIG. 11. The oil in the rodless cavity 1 may flow through the first balance valve 400, but since the switch valve 12 is cut off, the oil flowing through the first balance valve 400 cannot flow out from the first port G 8 through the switch valve 12 or enters the oil return system. The oil in the rodless cavity 1 of the hydraulic cylinder 200 is still sealed by the control valve 300, and the lifting arm of the aerial work platform does not move downward, causing the work bucket to tilt or causing the whole work platform to tip over, the safety of the aerial work platform is higher.

The aerial work platform may further include an oil supply system for supplying pressure oil to the derricking cylinder 100, and an oil return system for receiving the return oil. Wherein the oil supply system and the oil return system can conventionally include a fuel tank, a fuel supply pump, a fuel supply pipeline, a control valve 300 and the return pipeline, etc. The above system and the derricking cylinder 100 may have the existing connections and working modes. When the above-mentioned derricking cylinder 100 of the application is used for the existing aerial work platform, the oil supply system and the oil return system need not be modified, and only need to be connected with the existing oil supply system and the oil return system to operate normally, The application does not describe the oil supply system and the oil return system of the aerial work platform.

As shown in FIGS. 6 to 11, the control valve 300 may further include a hydraulic sensor 18 for monitoring the pressure on the oil circuit between the switch valve 12 and the first balance valve 400, and an electronic control unit electrically connected to the hydraulic sensor 18, and an alarm device electrically coupled to the electronic control unit. When the hydraulic sensor 18 detects that the pressure on the oil circuit between the switch valve 12 and the first balance valve 400 deviates from the preset range, the electronic control unit can control the alarm device to perform an alarm. The preset range can be determined through experiments, and the alarm operation of the alarm device can display the alarm information on the display or emit an alarm signal such as light or sound, which will not be described here. After the alarm device alarms, the maintenance personnel can know that the first balance valve 400 has failed, and may replace the first balance valve 400 to prevent long-term use causing the switch valve 12 fails, resulting in that the oil in the rodless cavity 1 cannot be sealed when the derricking cylinder 100 is at rest, and when the arm descends, the work bucket may be tilted or the entire aerial work platform may be tipped over to cause a dangerous accident. Therefore, by replacing the failed first balance valve 400, the control valve 300 can ensure double-insurance on the oil circuit from the rodless cavity 1 oil outflow, further improve the reliability of the control valve 300 and the safety of the aerial work platform.

Preferably, the switch valve 12 may be a two-position two-way solenoid valve or a proportional valve, and can further include an electronic control unit electrically connected to the switch valve 12, and the turn-on and turn-off of the switch valve 12 may be controlled by the electronic control unit. The control of the switch valve 12 is fast and efficient. The switch valve 12 can also be other types of valves, such as a valve of a mechanical control switch, a two-position three-way solenoid valve or a proportional valve, etc., as long as the ON/OFF of the switch valve 12 can be controlled The example is not limited to this.

It should be understood that the above-mentioned control unit may be obtained by extending the electronic control unit of an existing aerial work platform, or an electronic control unit additionally provided. The electronic control unit may include a memory, a processor, and a communication module and the like. The electronic control unit can be electrically connected with the control system of the aerial work platform, the hydraulic sensor 18, the electromagnetic switch valve 12 and the alarm device through the communication module, and can receive control signals from the control system such as the signals of upward variable amplitude, downward variable amplitude and at rest, etc. The electronic control unit may obtain an execution instruction after the memory and the processor process the received control signal, and can send an execution command to the electromagnetic switch valve 12 through the communication module to control ON/OFF of the electromagnetic switch valve 12, and receive the pressure signal from the hydraulic sensor 18. The electronic control unit may obtain an execution instruction after the memory and the processor process the received pressure signals, and can send an execution instruction to the alarm device through the communication module to control whether the alarm device performs an alarm.

Preferably, the first balance valve 400, the second balance valve 500 and the switch valve 12 can be integrated in one valve body. The first port G 8, the second port F 9, the third port H 10 and the fourth port E 11 are all located on the surface of the valve body, and the surface of the valve body is further provided with a fifth port M 13 connected to the oil circuit between the switch valve 12 and the first balance valve 400. The hydraulic sensor 18 can be provided on the fifth port M 13. The modular manufacture of the control valve 300 make it easy to install and versatile and can be installed on different models.

It should be understood that the above control valve 300 is a separate structure from the derricking cylinder 100, and is not limited to use with the above single-rod double-acting piston hydraulic cylinder 200, and can be used for other forms of hydraulic cylinders; Except used in the variable-speed cylinder, it can also be used in the telescopic cylinder of the aerial work platform; or it will not be used with the oil cylinder, but be used separately for other oil circuits that need to control the oil intake and oil return instead.

It should be understood that the first overflow function portion 5 of the first balance valve 400 of the above embodiment and the second overflow function portion 7 of the second balance valve 500 preferably adopt a pilot type structure. Optionally, the above first overflow function portion 5 of the first balance valve 400 and the second overflow function portion 7 of the second balance valve 500 may also adopt a common direct-acting structure, and the spring side control cavity of the overflow function portion does not have an external discharge port.

It should be understood that the first balance valve 400 and the second balance valve 500 are simultaneously operated for controlling the oil intake and the oil return, and the specific structures of the above-described first balance valve 400 and second balance valve 500 are not limited to the structure of the above embodiment, as long as the first balance valve 400 and the second balance valve 500 are ensured to work synchronously so that the control valve 300 can control the hydraulic cylinder 200 the oil intake and the oil return. The first balance valve 400 may include the first one-way functional portion 4 and the first overflow function portion 5, the second balance valve 500 may include the second one-way functional portion 6 and the second overflow function portion 7. The control port of the first overflow function portion 5 communicates with the first oil mouth 17 at one end of the oil inlet of the second one-way function portion 6 of the second balance valve 500, and the control port of the second overflow function portion 7 communicates with the second oil mouth 14 at one end of the oil inlet of the first one-way function portion 4 of the first balance valve 400, and the third oil mouth 15 at one end of the oil inlet of the first overflow function portion 5 of the first balance valve 400 is connected to the second port F 9. The first balance valve 400 and the second balance valve 500 may be other structures, as long as one oil mouth of the first balance valve 400 is connected to the first port G 8, and the other oil mouth of the first balance valve 400 is connected to the second port F 9, one oil mouth of the second balance valve 500 is connected to the third port H 10, and the other oil mouth of the second balance valve 500 is connected to the fourth port E 11.

It should be understood that the function of the second balance valve 500 provided on the oil circuit between the third port H 10 and the fourth port E 11 is to prevent the piston rod 3 being rebounded caused by the pressure wave shock when the first balance valve 400 is cut off, then resulting in discomfort to the operator since the lifting portion of the aerial work platform shakes. When this point is not taken into account, the second balance valve 500 may not be provided on the oil circuit between the third port H 10 and the fourth port E 11. At this time, the control port of the first overflow function portion communicate with the oil circuit between the third port H 10 and the fourth port E 11. Since the hydraulic oil in the hydraulic cylinder 200 is subjected to pressure under the action of gravity, even on the oil circuit between the third port H 10 and the fourth port E 11, the second balance valve 500 may not be provided, and the control function of the control valve 300 is not affected.

It should be understood that the control valve 300 of the derricking cylinder 100 of the above embodiment is configured to be able to determine whether the first balance valve 400 is disabled by monitoring the pressure at the second oil mouth 14 of the first balance valve 400, and the switch valve 12 is set on the oil circuit between the first balance valve 400 and the first port G 8, and is connected in series with the first balance valve 400. When it is not necessary to monitor the pressure to determine whether the first balance valve 400 fails and alarms, the switch valve 12 can also be provided on the oil circuit between the first balance valve 400 and the second port F 9, and is connected in series with the first balance valve 400. When the derricking cylinder 100 is at rest, the above control valve 300 can still provide double insurance by cutting off the switch valve 12 and cutting off the first balance valve 400 return circuit. Seal the oil in the rodless cavity 1 of the derricking cylinder 100. Even if the first balance valve 400 fails, the oil can be prevented from returning from the oil circuit between the first port G 8 and the second port F 9 by cutting off the switch valve 12, and the control valve 300 still has high operational reliability.

It should be understood that the control valve 300 of the derricking cylinder 100 of the above embodiment will make the first balance valve 400, the second balance valve 500, and the switch valve 12 integrated in one valve body, and the first balance valve 400, the second balance valve 500, and the switch valve 12 may be divided into different valve bodies.

The above-described derricking cylinder 100 can be used in an aerial work platform disclosed in the aforementioned Chinese Patent with Publication No. CN201810449467.2. The aerial work platform includes a lifting portion and a walking portion, the walking portion includes a base, and the lifting portion includes a folding arm, a main arm, a secondary arm and a work bucket which are sequentially connected. One end of the folding arm is hinged to a turntable, the turntable is connected to the base by a slewing bearing. One end of the main arm is hinged to the other end of the folding arm, one end of the secondary arm is hinged to the other end of the main arm. The work bucket is connected to the other end of the secondary arm. A small arm head is provided at a joint of the main arm connected with the secondary arm, and a small arm leveling cylinder is provided between the small arm head and the main arm. The folding arm is a telescopic structure or includes a link mechanism, and the folding arm is internally provided with a folding arm telescopic cylinder for controlling the telescopic movement of the folding arm. A folding arm derricking cylinder 100 is provided between the folding arm and the turntable. The main arm has a retractable structure, and is internally provided with a main arm telescopic cylinder for controlling the main arm's telescopic movement. A main arm derricking cylinder is provided between the main arm and the folding arm, and a secondary arm derricking cylinder is provided between the secondary arm and the main arm. At least one of the folding arm derricking cylinder, the main arm derricking cylinder and the secondary arm derricking cylinder is the above-described derricking cylinder 100.

It should be understood that the above-described derricking cylinder 100 is not limited to the aerial work platform of the above specific structure, and can also be used for an aerial work platform having other lifting portions of other structures, and the above-mentioned derricking cylinder 100 is provided on the lifting portion of the aerial work platform, such that it is used to drive the lifting portion for lifting.

The above is only a specific embodiment of the present disclosure, but the scope of the present disclosure is not limited thereto. Any person skilled in the art can easily think of various kinds of equivalent modifications or substitutions within the technical scope disclosed by the present disclosure. Equivalent modifications or substitutions are intended to be included within the scope of the present disclosure. Therefore, the scope of protection of the present disclosure should be determined by the scope of the claims.

1. A control valve (300) comprising an oil circuit provided between a first port G (8) and a second port F (9), and an oil circuit provided between a third port H (10) and a fourth port E (11); wherein, a first balance valve (400) connected in series with a switch valve (12) is provided in the oil circuit between the first port G (8) and the second port F (9).

2. The control valve according to claim 1, wherein the switch valve (12) is a two-position two-way solenoid valve or a proportional valve, and the control valve further comprises an electronic control unit electrically connected to the switch valve (12).

3. The control valve according to claim 1, wherein the first balance valve (400) and the switch valve (12) are integrated in one valve body, and the first port G (8), the second port F (9), the third port H (10) and the fourth port E (11) are located on a surface of the valve body.

4. The control valve according to claim 1, wherein the first balance valve (400) comprises a first one-way functional portion (4) and a first overflow function portion (5), a control port of the first overflow function portion (5) communicates with the oil circuit between the third port H (10) and the fourth port E (11); and a third oil mouth (15) located at one end of the oil inlet of the first overflow function portion (5) of the first balance valve (400) is connected to the second port F (9), a second oil mouth (14) located at one end of the oil inlet of the first one-way function portion of the first balance valve (400) is connected to the first port G (8).

5. The control valve according to claim 4, wherein the first overflow function portion (5) is a pilot type structure, and a spring side control cavity of the first overflow function portion (5) is in communication with an oil outlet of the first overflow function portion (5), and a spring-free side control cavity of the first overflow function portion (5) is in communication with an oil inlet of the first overflow function portion (5).

6. The control valve according to claim 1, wherein a second balance valve (500) is provided on the oil circuit between the third port H (10) and the fourth port E (11).

7. The control valve according to claim 6, wherein the first balance valve (400), the second balance valve (500), and the switch valve (12) are integrated in one valve body, the first port G (8), the second port F (9), the third port H (10) and the fourth port E (11) are located on a surface of the valve body.

8. The control valve according to claim 7, wherein the first balance valve (400) comprises a first one-way functional portion (4) and a first overflow function portion (5), and the second balance valve (500) comprises a second one-way functional portion (6) and a second overflow function portion (7); the control port of the first overflow function portion (5) is in communication with a first oil mouth (17) located at one end of the oil inlet of the second one-way function portion (6) of the second balance valve (500); and the control port of the second overflow function portion (7) is in communication with a second oil mouth (14) located at one end of the oil inlet of the first one-way function portion (4) of the first balance valve (400); and a third oil mouth (15) located at one end of the oil inlet of the first overflow function portion (5) of the first balance valve (400) is connected to the second port F (9); and the second oil mouth (14) is connected to the first port G (8), the first oil mouth (17) is connected to the third port H (10); and a fourth oil mouth (16) located at one end of the oil inlet of the second overflow function portion (7) of the second balance valve (500) is connected to the fourth port E (11).

9. The control valve according to claim 8, wherein both the first overflow function portion (5) and the second overflow function portion (7) are pilot type structures, and a spring side control cavity of the first overflow function portion (5) communicates with the oil outlet of the first overflow function portion (5), a spring-free side control cavity of the first overflow function portion (5) communicates with the oil inlet of the first overflow function portion (5); and a spring side control cavity of the second overflow function portion (7) communicates with the oil outlet of the second overflow function portion (7), and a spring-free side control cavity of the second overflow function portion (7) is in communication with the oil inlet of the second overflow function portion (7).

10. The control valve according to claim 7, wherein the switch valve (12) is provided on an oil circuit between the first port G (8) and the first balance valve (400), and the control valve further comprises a hydraulic sensor (18) configured to monitor the pressure on the oil circuit between the switch valve (12) and the first balance valve (400); an electronic control unit electrically connected to the hydraulic sensor (18); and an alarm device electrically connected to the electronic control unit.

11. The control valve according to claim 10, wherein the valve body surface is further provided with a fifth port M (13), and the fifth port M (13) is connected to the oil circuit between the switch valve (12) and the first balance valve (400), and the hydraulic sensor (18) is arranged on the fifth port M (13).

12. A derricking cylinder (100) comprising: a hydraulic cylinder (200) and a control valve (300), the hydraulic cylinder (200) being a single rod double acting piston type hydraulic cylinder, the second port F (9) communicates with the rodless cavity (1) of the hydraulic cylinder (200), and the fourth port E (11) communicates with the rod cavity (2) of the hydraulic cylinder (200).

13. An aerial work platform comprising a lifting portion and a walking portion, the lifting portion comprising the derricking cylinder (100), the derricking cylinder (100) is configured for driving the lifting portion to be lifted and lowered.

14. The aerial work platform according to claim 13, wherein the walking portion comprises a base, and the lifting portion comprises a folding arm, a main arm, a secondary arm and a work bucket, which are sequentially connected; one end of the folding arm is hinged to a turntable, the turntable is connected to the base by a slewing bearing; one end of the main arm is hinged to the other end of the folding arm, one end of the secondary arm is hinged to the other end of the main arm; the work bucket is connected to the other end of the secondary arm; a small arm head is provided at a joint of the main arm connected with the secondary arm, and a small arm leveling cylinder is provided between the small arm head and the main arm; the folding arm is a telescopic structure or comprises a link mechanism, and the folding arm is internally provided with a folding arm telescopic cylinder for controlling the telescopic movement of the folding arm; a folding arm derricking cylinder is provided between the folding arm and the turntable; the main arm has a retractable structure, and is internally provided with a main arm telescopic cylinder for controlling the main arm's telescopic movement; a main arm derricking cylinder is provided between the main arm and the folding arm, and a secondary arm derricking cylinder is provided between the secondary arm and the main arm; at least one of the folding arm derricking cylinder, the main arm derricking cylinder and the secondary arm derricking cylinder is the derricking cylinder (100).
